(19) United States
(12) Patent Application Publication
(10) Pub. No.: US 2006/0055634 A1
(43) Pub. Date: Mar. 16, 2006

(54) Data control unit for a plasma display panel and method of using the same

(76) Inventor: Jung Gwan Han, Gumi-si (KR)

Correspondence Address: MCKENNA LONG & ALDRIDGE LLP, 1900 K STREET, NW, WASHINGTON, DC, 20006, US

(21) Appl. No.: 11/157,980

(22) Filed: Jun. 22, 2005

(30) Foreign Application Priority Data
Sep. 13, 2004 (KR) 10-2004-0073104

(51) Int. Cl. G09G 3/28

(52) U.S. Cl. 345/60

(57) ABSTRACT

The present invention relates to a method and apparatus for data control in a plasma display panel that reduces power consumption and heat generation in a data driving circuit. A plasma display apparatus according to an embodiment of the present invention comprises a scan driver for scanning the scan electrodes; a data driver for supplying a data signal corresponding to a scan sequence to the data electrodes; and a controller for controlling the scan driver and the data driver, the controller controlling the scan driver in order to perform a first scan for sequentially scanning odd numbered scan electrodes and a second scan for sequentially scanning even numbered scan electrodes, when a data pattern of input data includes a data pattern which repeats a logical inversion for sub pixels in a column direction.

This nonprovisional application claims priority under 35 U.S.C. § 119(a) to Korean Patent Application No. 10-2004-0073104, filed on Sep. 13, 2004, which is hereby incorporated by reference for all purposes as if fully set forth herein.

### BACKGROUND OF THE INVENTION

1. Field of the Invention

The present invention relates to a data control unit for a plasma display panel, and more particularly to a method and apparatus for data control of a plasma display panel that reduces power consumption and heat generation in a data driving circuit.

2. Description of the Background Art

There is a growing interest in flat panel display devices capable of reducing the weight and the volume of the display device as compared to a cathode ray tube (“CRT”). These flat panel display devices can include a liquid crystal display (“LCD”), a plasma display panel (“PDP”), a field emission display (“FED”), electro-luminescence (“EL”), and the like. These flat panel display devices supply a digital signal or analog data to the display panels.

Of these flat panel display devices, the PDP is adapted to display an image of characters or graphics using light-emitting phosphors excited by ultraviolet light of about 147 nm generated during the discharge of a gas, for example, He+Xe, Ne+Xe or He+Ne+Xe. A PDP can easily be made large and thin, and with the recent development of the relevant technology, it can provide great increases in image quality. Particularly, a three-electrode AC surface discharge type PDP has the advantages of lower driving voltage and longer product lifespan because wall charges accumulate on a surface upon discharge and the electrodes are protected from sputtering caused by discharge.

The three-electrode AC surface discharge type PDP displays different gray scale level by dividing each frame into a plurality of sub-fields each having a different number of discharges. Each sub-fields is divided into a reset period for uniformly generating discharge, an address period for selecting a discharge cell, and a sustain period for implementing the gray level according to the number of discharges. For example, to display an image with a gray scale of 256, a flame period corresponding to 1/60 seconds (16.67 ms) is divided into eight sub-fields SF1 to SF8, as shown in FIG. 1. Each of the sub-fields SF1 to SF8 are subdivided into the reset period, the address period, and the sustain period, as described-above. As illustrated in FIG. 1, the reset period and the address period in each sub-field SF1 to SF8 is the same, however, the sustain period increases in each sub-field by the ratio of 2ⁿ(n=0,1,2,3,4,5,6,7). It is the varying sustain period varies in each sub-field which allows the gray scale of an image to be implemented.

However, the driving voltage required to cause a discharge to occur between two electrodes in a PDP is relatively high due to the discharge characteristic and the large size of the panel, resulting in relatively high power consumption. Furthermore, a driver integrated circuit (“IC”) for driving data electrodes and scan electrodes of the PDP must supply a high voltage to electrodes Y, Z and X, respectively, in order to generate discharge. Therefore, the power consumed and heat generated are relatively high.

In a PDP, power is consumed primarily during the sustain period and secondarily during the address period. For example, the sustain period requires several hundreds of watts, and the address period requires several tens of watts. Power consumption during the sustain period primarily depends upon the efficiency of the PDP, while power consumption during the address period depends primarily upon the switching frequency of the drive ICs and the capacitance C and voltage V of the PDP.

The capacitance (C) of the PDP, as shown in FIG. 2, includes a capacitance (C1) between adjacent data electrodes (X1 to Xn), a capacitance (C2) between data electrodes (X1 to Xn) and adjacent scan electrodes (Y1 to Ym), a capacitance (C3) between the scan electrode (Y1 to Ym) and adjacent common sustain electrode (Z), and a capacitance (C4) between the address electrodes (X1 to Xn) and the common sustain electrode (Z). At least 90% of the power consumed during the address period is a result of a displacement current which is generated upon charge/discharge of the PDP. The amount of the power consumed during the address period, which is generated by the displacement current, can be expressed by the following Equation 1.
P=IV=CV²f (1)
where I is the current, V is the voltage of data pulse, C is a capacitance value between the address electrode (X) and other electrodes (Y, Z) adjacent thereto, and f is the average switching frequency per unit of time of the data driver IC.

However, if an energy recovery circuit is adapted in the data driver IC, the power consumption of the data driver IC can be expressed by the following Equation 2:
P=IV=CV²f(1−α) (2)
where α represents the energy recovery efficiency of the energy recovery circuit. In the data driver IC, the energy recovery efficiency α is about 0.5 maximum.

As can be seen from Equations 1 and 2, there are four options for reducing the amount of power consumed, reduce the current I, reduce the capacitance C, reduce the voltage, or reduce the switching frequency. However, methods for reducing the voltage are limited due the fact that in order to generate discharge in a discharge cell a certain voltage is required. In addition, method for reducing the capacitance C of a panel are limited to the desire for larger high resolution panels.

The switching frequency f of the data driver IC is highest when the data pattern has alternating High and Low logic levels in adjacent discharge cells in both the column and row direction, as illustrated in FIG. 3. In other words, the data pattern illustrated in FIG. 3 requires the data driver IC to repeatedly turn on and off a switching element with ever horizontal signal.

If the switching element of the data driver IC repeatedly turns on and off every horizontal period, there are problems in that the power consumed is high and heat is generated in the data driver IC. Actually, if the data pattern as illustrated in FIG. 3 is consistently supplied for an extended time, extreme heat can be generated in the data driver IC, damaging the data driver IC.

Furthermore, the switching frequency f of the data driver IC is also high when the data pattern has alternating High and Low logic levels in adjacent pixel cells in both the column and row direction, as illustrated in FIG. 4, where a pixel cell 20 includes for example, a red sub-pixel R, a green sub-pixel G, and a blue sub-pixel. In other words, the data pattern illustrated in FIG. 3 requires the data driver IC to repeatedly turn on and off a switching element which every horizontal signal.

In addition, when the above-identified data patterns are displayed where it a large voltage difference between adjacent cells, resulting in high capacitance (C) in the PDP.

As can be seen from the above, in the data patterns illustrated in FIGS. 3 and 4, the capacitance of the PDP and the switching frequency f of the data driver IC are both high, resulting in a high displacement current. Therefore, the power consumed and heat generated are relatively high when either of these patterns are displayed.

### SUMMARY OF THE INVENTION

Accordingly, the present invention is directed to a data control unit for a plasma display panel and method of using same that substantially obviates one or more of the problems due to limitations and disadvantages of the related art.

According to an embodiment of the present invention, a plasma display apparatus including scan electrodes and data electrodes intersecting the scan electrodes, the apparatus comprises a scan driving unit that scans the scan electrodes according to a scan sequence; a data driving unit that supplies a data signal corresponding to the scan sequence to the data electrodes; and a control unit that controls the scan driver and the data driver; the control unit controlling the scan driver in order to perform a first scan for sequentially scanning odd numbered scan electrodes, and a second scan for sequentially scanning even numbered scan electrodes, when input data includes a data pattern which repeats a logical inversion for cells in a column direction.

### BRIEF DESCRIPTION OF THE DRAWINGS

The accompanying drawings, which are included to provide a further understanding of the invention illustrate embodiments of the invention and together with the description serve to explain the principles of the invention.

FIG. 1 illustrates a frame of a general plasma display panel.

FIG. 2 illustrates an equivalent circuit diagram representing the capacitance of a PDP.

FIG. 3 illustrates a plasma display panel data pattern.

FIG. 4 illustrates another plasma display panel data pattern.

FIG. 5 is a diagram illustrating a data control unit of a plasma display panel according to an embodiment of the present invention.

FIG. 6 is a diagram illustrating a driving device connected to a display panel.

FIGS. 7A and 7B are diagrams illustrating an operation process of a first embodiment of the data control unit in case that the data pattern shown in FIG. 3 is inputted.

FIGS. 8A and 8B are diagrams illustrating the polarity of data supplied to the panel by the operation process shown in FIGS. 7A and 7B.

FIGS. 9A and 9B are diagrams illustrating an operation process of the first embodiment of the data control unit in case that the data pattern shown in FIG. 4 is inputted.

FIGS. 10A and 10B are diagrams illustrating the polarity of data supplied to the panel by the operation process shown in FIGS. 9A and 9B.

FIGS. 11A and 11B are diagrams illustrating an operation process of a second embodiment of the data control unit in case that the data pattern shown in FIG. 3 is inputted.

FIGS. 12A and 12B are diagrams illustrating an operation process of the second embodiment of the data control unit in case that the data pattern shown in FIG. 4 is inputted.

FIG. 13 is a diagram schematically illustrating a data pattern which is repeated for every two scan electrodes.

FIG. 14 is a diagram schematically illustrating a data pattern which is repeated for every two scan electrodes.

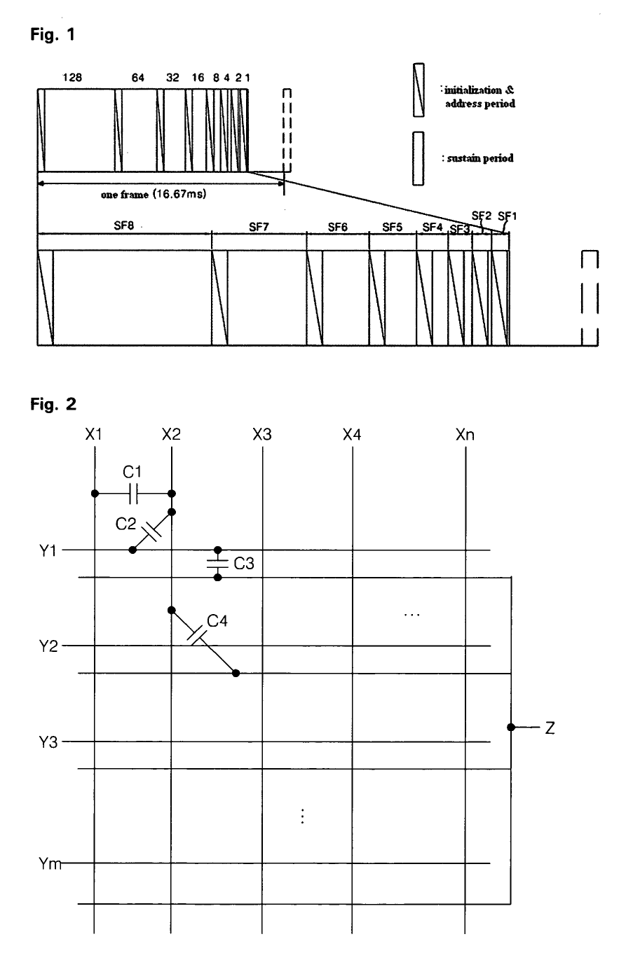

### DETAILED DESCRIPTION OF EMBODIMENTS

Reference will now be made in detail to embodiments of the present invention, examples of which are illustrated in the accompanying drawings.

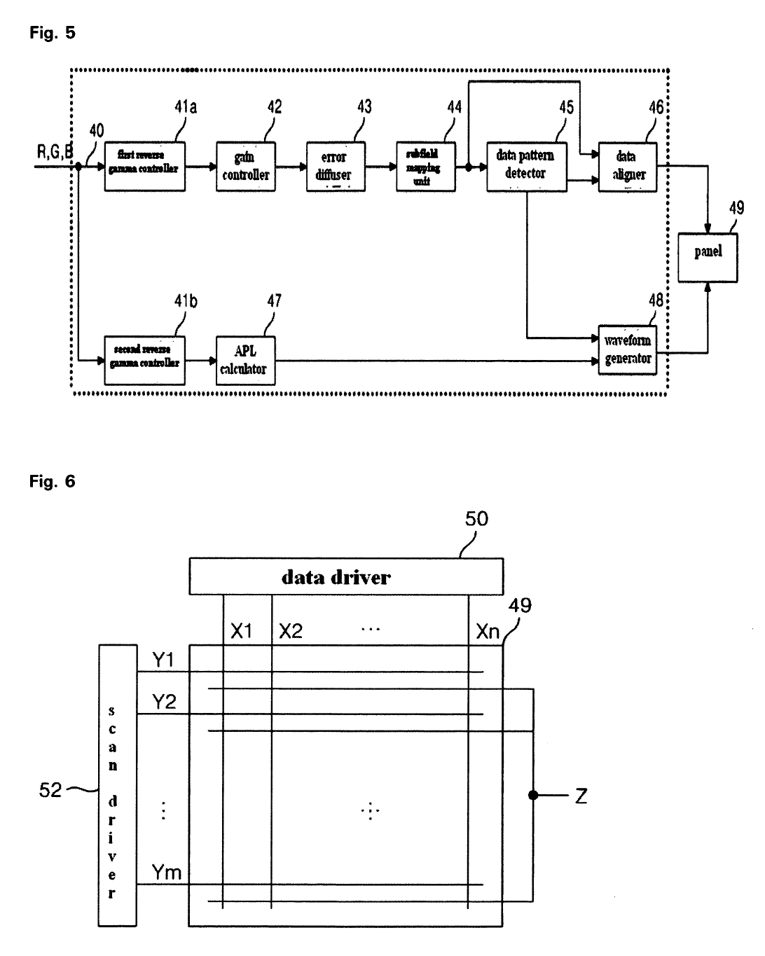

FIG. 5 illustrates a data control unit for a plasma display panel according to an embodiment of the present invention. Referring to FIG. 5, the data control unit includes a first reverse gamma controller (41A), a data aligner (46), and a gain controller (42), an error diffuser (43), a subfield mapping unit (44), and a data pattern detector (45) connected between the first reverse gamma controller (41A) and the data aligner (46). In addition, the data control unit includes a second reverse gamma controller (41B), a waveform generator (48), and an APL calculator (47) connected between the second reverse gamma controller (41 B) and the waveform generator (48).

The first and second reverse gamma controllers (41A and 41B) reverse gamma correct digital video data R,G,B received from input line (40) to linearly convert brightness for the gray level value of a video signal.

The gain controller (42) compensates for color variation due to temperature by controlling the effective gain of red, green and blue data. The error diff-user (43) minutely controls brightness by diffusing the quantum error of the digital video data RGB received from the gain controller (42). The subfield mapping unit (44) maps the data received from the error diffuser (43) to pre-stored subfield bit patterns, and supplies the mapped data to the data pattern detector (45).

The dat pattern detector (45) detects predefined data patterns based on the bits mapped to each subfield and supplies a control signal corresponding to the detected data pattern to the waveform generator (48) and the data aligner (46). The waveform generator (48) controls the scan sequence so as to correspond to the control signal supplied from the data pattern detector (45). Accordingly, the scan sequence may be different for each sub-field.

The data aligner (46) supplies the digital video data inputted from the subfield mapping unit (44) to a data driver (50) of the panel (49). The data aligner (46) controls the supply sequence of the data such that it corresponds to the control signal supplied from the data pattern detector (45).

The APL calculator (47) calculates an average brightness on a screen basis for the digital video data RGB inputted from the second reverse correction part (41B), i.e., an average picture level (APL), and outputs the information regarding the number of sustain pulses corresponding to the calculated APL.

The waveform generator (48) responds to the sustain pulse information from the APL calclulator (47) to generate a timing control signal, and supplies the generated timing control signal to the panel (49). The panel (49) displays a picture corresponding to the data supplied from the data aligner (46). For this, a data driver (50) and a scan driver (52), illustrated in FIG. 6, are connected to the panel (49).

Referring to FIG. 6, the data driver (50) converts the data supplied from the data aligner (46) into a data signal, and supplies the converted data signal to the data electrodes (X1 to Xn). The scan driver (52) responds to the control signal supplied from the waveform generator 48 to supply a scan pulse to the scan electrodes (Y1 to Ym). The scan pulses may be applied to each scan electrode sequentially, or the scan electrodes (Y1 to Ym) may be divided into two or more blocks in response to the control signal and the scan pulses may be applied to each block sequentially.

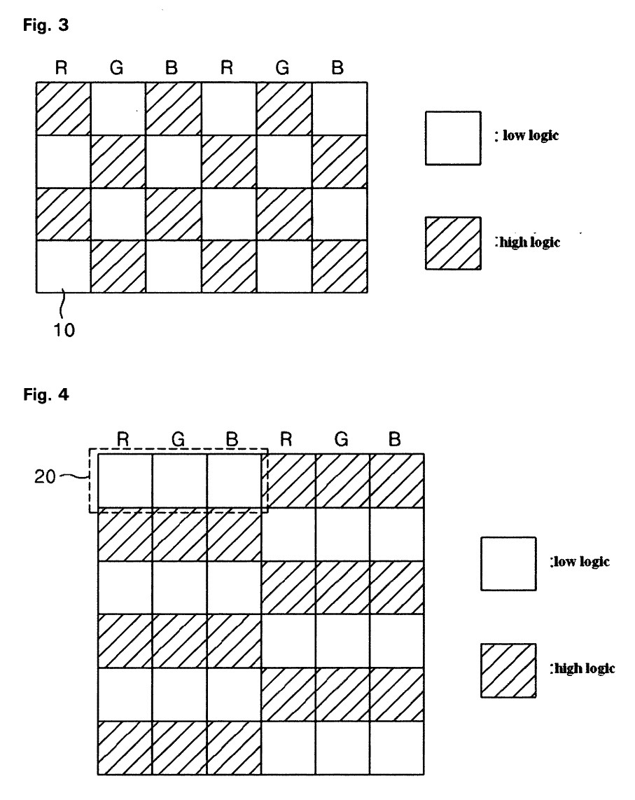

Referring back to the detection of the predefined bit patterns, the data pattern detector (45) determines if the detected data pattern comprises a repeating pattern of high and low logic between each discharge cell (10) or each pixel cell (20) in both the column and row direction as illustrated in FIGS. 3 and 4. It should be noted that although the present invention is described with regard to only the data patterns illustrated in FIGS. 3 and 4, other repeating data patterns may exsist and be detected.

If the pattern detected at the data pattern detector (45) is not a predefined repeating data pattern, for example those illustrated in FIGS. 3 and 4, the data pattern detector (45) supplies a general pattern control signal to the waveform generator (48) and the data aligner (46). The waveform generator (48) receiving the general pattern control signal controls the scan driver (52) such, that a scan pulse is sequentially supplied to the first scan electrode (Yl) to the m^{th} scan electrode (Ym). The data aligner (46) receiving the general pattern control signal aligns the data and supplies the aligned data to the data driver (50) such that the data signal is sequentially supplied to the discharge cells connected to the first scan electrode (Y1) to the discharge cells connected to the m^{th} scan electrode (Ym).

On the other hand, if a repeating data pattern is detected, for example either of the data patterns illustrated in FIGS. 3 and 4, the data pattern detector (45) supplies a repeat pattern control signal to the waveform generator (48) and the data aligner (46).

When the waveform generator (48) receives a repeat pattern control signal it controls the scan driver (52) so that scan pulses are supplied to scan electrodes (Y1 to Ym) in a predefined scan sequence associated with the repeating pattern. For example, if either of the patterns illustrated in FIGS. 3 and 4 are detected, the scan electrodes are divided into two blocks, and the scan pulses are supplied to each scan eletrode within a block sequentially. More specifically, the scan driver (52) divides the scan electrodes into odd numbered scan electrodes (Y1, Y3, Y5, . . . ) and even numbered scan electrodes (Y2, Y4, Y6, . . . ) by the control of the waveform generator (48). Thereafter, a scan pulse is squentially to each of the odd numbered scan electrodes, then a scan pulse is sequentially supplied to the even numbered scan electroes, or vice versa. It does not make a difference which block of scan electrodes comes first between the step of scanning the odd numbered scan electrodes and the step of scanning the even numbered scan electrodes.

The data aligner (46) receiving the repeat pattern control signal alignes the data to correspond to the scan sequence and supplies the aligned data to the data driver (50). For example, if the scan sequence is the odd and even sequence discussed above, the data aligner (46) supplies the data corresponding to the odd numbered scan electrodes (Y1, Y3, Y5, . . . ), and then supplies the data corresponding to the even numbered scan electrodes (Y2, Y4, Y6, . . . ). The data driver (50) converts the data supplied from the data aligner (46) into the data signal and supplies the converted data signal to the data electrodes (X1 to Xn).

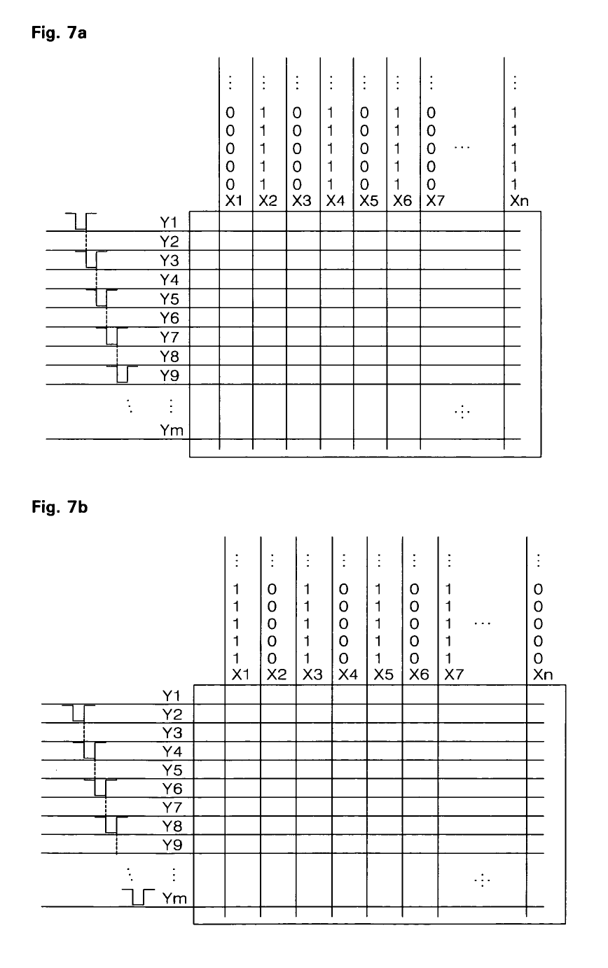

To describe the operation process in detail assuming that the data pattern, where the high logic and the low logic are repeated in the column direction and the row direction of the discharge cell (10) as in FIG. 3, is detected, first the scan driver (52) supplies the scan pulse to the odd numbered scan electrodes (Y1, Y3, Y5, . . . ), as illustrated in FIG. 7A, then the even numbered scan electrodes (Y2, Y4, Y6, . . . ) as illustrated in FIGS. 7B.

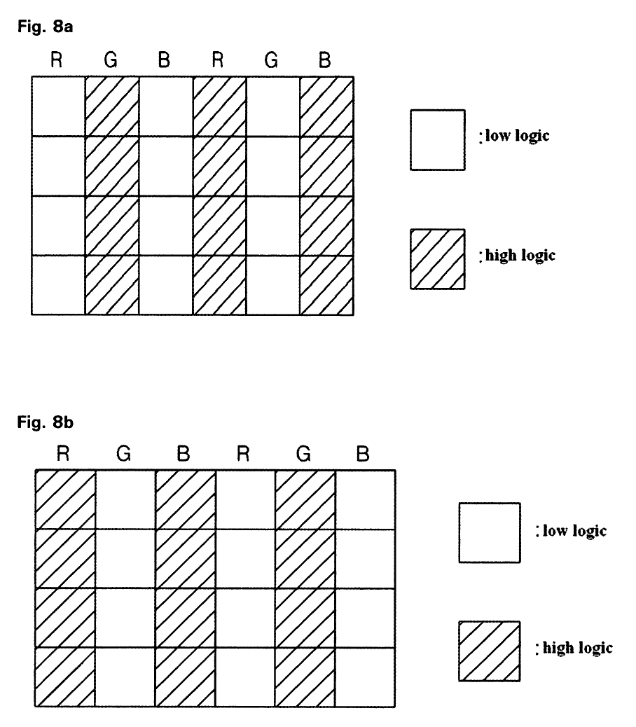

When the scan pulse is supplied to the odd numbered scan electrodes (Y1, Y3, Y5, . . . ), the data signal of the same polarity is supplied to each of the data electrodes (X1 to Xn), as illustrated in FIG. 7A. In other words, the polarity of the data signal supplied to each of the data electrodes (X1 to Xn) does not change each horizontal signals, but rather maintains the same polaity until the scan pulse is supplied to all the odd numbered scan electrodes (Y1, Y3, Y5, . . . ) as illustrated in FIG. 8A.

After the scan pulse is supplied to all odd numbered scan electrodes (Y1, Y3, Y5, . . . ), the scan driver (52) sequentially supplies the scan pulse to the even numbered scan electrodes (Y2, Y4, Y6, . . . ) as illustrated in FIG. 7B. Accordingly, the polarity of the data signal supplied to each of the data electrodes (X1 to Xn) does not change each horizontal signal, but rather maintains the same polarity until the scan pulse is supplied to all the even numbered scan electrodes (Y2, Y4, Y6, . . . ) as illustrated in FIG. 8B. In fact, the polarity of the data signal supplied to the data electrodes (X1 to Xn) is changed only when the scan pulse is supplied to the first even numbered scan electrode (Y2) after the scan pulse is supplied to the last odd numbered scan electrode (Ym-1), and it maintains the same polarity elsewhere.

According to the present invention, the switching devices of the data driver (50) maintains the same state (on or off state) during the period when the scan pulse is supplied to all the odd numbered scan electrodes (Y1, Y3, Y5, . . . ) and during the period when the scan pulse is supplied to the all the even numbered scan electrodes (Y2, Y4, Y6, . . . ). Accordingly, power consumption is reduced and it is possible to prevent high heat from being generated in the data driver (50).

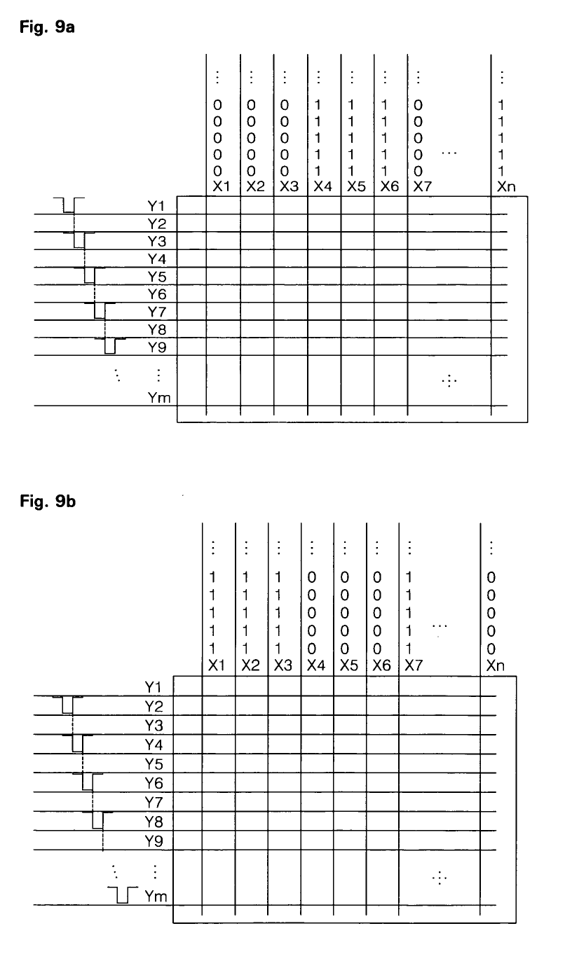

When a data pattern, where high and low logic are repeated in the column direction and the row direction of the pixel cell (20), is detected, the scan driver (52) supplies the scan pluse to the odd numbered scan electrodes (Y1, Y3, Y5, . . . ) and the even numbered scan electrodes (Y2, Y4, Y6, . . . ) as illustrated in FIGS. 9A and 9B.

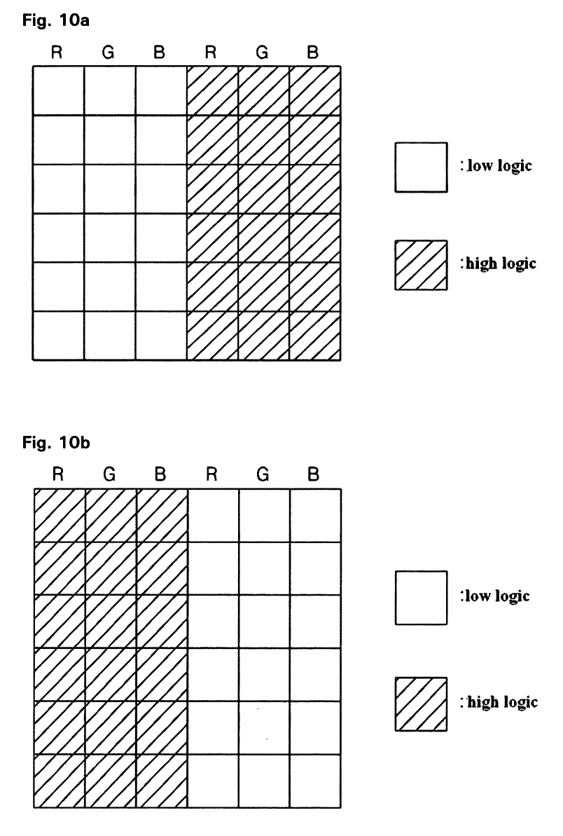

When the scan pulse is supplied to the odd numbered scan electrodes (Y1, Y3, Y5, . . . ) as in FIG. 9A, the data signal of the same polarity (high or low) is supplied to each of the data electrodes (X1 to Xn). In other words, the polarity of the data signal supplied to each of the data electrodes (X1 to Xn) does not change each horizontal signal, but rather maintains the same polarity until the scan pulse is supplied to all the odd numbered scan electrodes (Y1, Y3, Y5, . . . ) as illustrated in FIG. 10A.

After the scan pulse is supplied to all odd numbered scan electrodes (Y1, Y3, Y5, . . . ), the scan driver (52) sequentially supplies the scan pulse to the even numbered scan electrodes (Y2, Y4, Y6, . . . ) as illustrated in FIG. 9B. At this moment, the data driver (50) supplies the data signal having the same polarity to each of the data electrodes (X1 to Xn). In other words, the polarity of the data signal supplied to each of the data electrodes (X1 to Xn) does not change each horizontal signal, but rather maintains the same polarity until the scan pulse is supplied to all the even numbered scan electrodes (Y2, Y4, Y6, . . . ) as illustrated in FIG. 10B. In fact, the polarity of the data signal supplied to the data electrodes (X1 to Xn) changes only when the scan pulse is supplied to the first even numbered scan electrode (Y2) after the scan pulse is supplied to the last odd numbered scan electrode (Ym-1), and it maintains the same polarity elsewhere.

According to the present invention, the switching devices of the data driver (50) maintains the same on or off state (high or low state) during the period when the scan pulse is supplied to all the odd numbered scan electrodes (Y1, Y3, Y5, . . . ) and the period when the scan pulse is supplied to the all the even numbered scan electrodes (Y2, Y4, Y6, . . . ). Accordingly, power consumption is reduced and it is possible to prevent high heat from being generated in the data driver (50).

As described above, in accordance with the invention, when the predefined data pattern is detected, the scan electrodes are divided into two blocks and the scan pulse is sequentially supplied to each of the blocks. However, the scan electrodes may be divided into more that two blocks. For example, the scan electrodes (Y1 to Ym) may be divided into four blocks to receive the scan pulses.

The waveform generator (48) receiving the repeat pattern control signal from the data pattern detector (45) divides the scan electrodes (Y1 to Ym) into four blocks and controls the the scan driver (52) so that the scan pulse is sequentially supplied to each of the four blocks. Herein, the scan electrodes (Y1 to Ym) are divided into a first block (Y1, Y5, Y9, . . . ) including the i^{1h} (where i is 1, 5, 9, 13, . . . ) scan electrodes Yi, a second block (Y2, Y6, Y10, . . . ) including the (i+1)^{th} scan electrodes (Yi+1), a third block (Y3, Y7, Y11, . . . ) including (i+2)^{th} scan electrodes (Yi+2), and a fourth block (Y4, Y8, Y12, . . . ) including (i+3)^{th} scan electrodes (Yi+3). The scan driver (52) sequentially supplies the scan pulse to the scan electrodes included in each of the first, second, third, and fourth blocks. That is, the scan driver (52) executes the step of continuously scanning the scan electrodes included in the first block, the step of continuously scanning the scan electrodes inlcuded in the second block, the step of continuously scanning the scan electrodes included in the third block, and the step of continuously scanning the scan electrodes inlcuded in the fourth block.

The data aligner (46) receiving the repeat pattern control signal aligns the data to correspond to the scan sequence and supplies the aligned data to the data driver (50). In other words, the data aligner (46) supplies the data corresponding the specific scan sequence to the data driver (50).

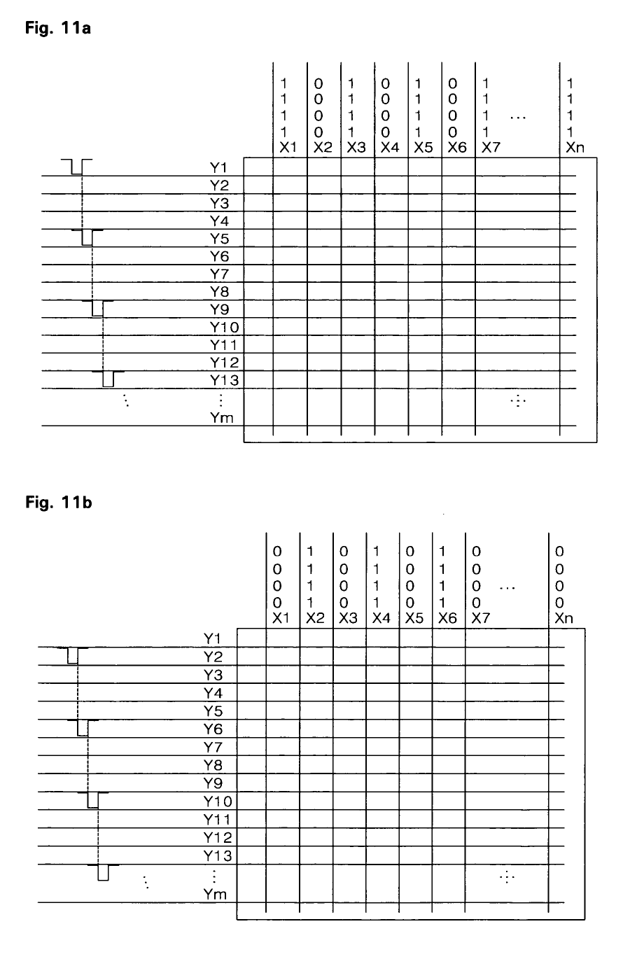

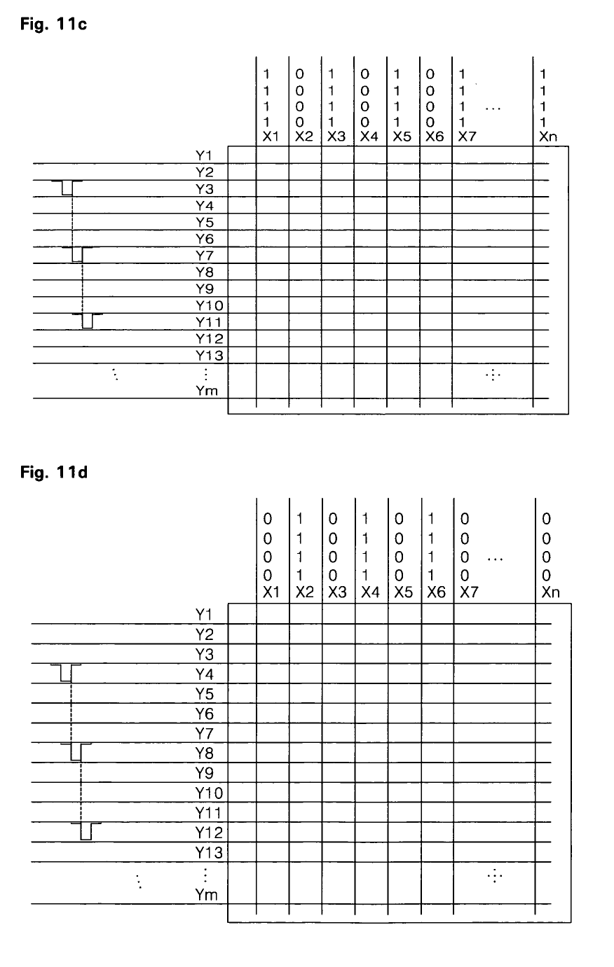

To describe the operation process in detail, assuming that the data pattern illustrated in FIG. 3 is detected, first the scan driver (52) supplies a scan pulse to the i^{th} scan electrode (Yi), the (i+1)^{th} scan electrode (Yi+1), the (i+2)^{th} scan electrode (Yi+2), and the (i+3)^{th} scan electrode (Yi+3) as illustrated in FIGS. 11A to 11D.

Then, as shown in FIGS. 11A to 11D, when the scan pulse is supplied to the i^{th} scan electrode (Yi), (i+1)^{th} scan electrode (Yi+1), (i+2)^{th} scan electrode (Yi+2), (i+3)^{th} scan electrode (Yi+3), the data signal of the same polarity is supplied to each of the data electrodes (X1 to Xn). In fact, the polarity of the data signal supplied to each of the data electrodes (X1 to Xn) is changed when the scan pulse is supplied to the first (i+1)^{th} scan electrode (Yi+1) (the first scan electrode of the second block), the first (i+2)^{th} scan electrode (Yi+2) (the first scan electrode of the third block) and the first (i+3)^{th} scan electrode (Yi+3) (the first scan electrode of the fourth block), but maintains the same polarity in the other cases.

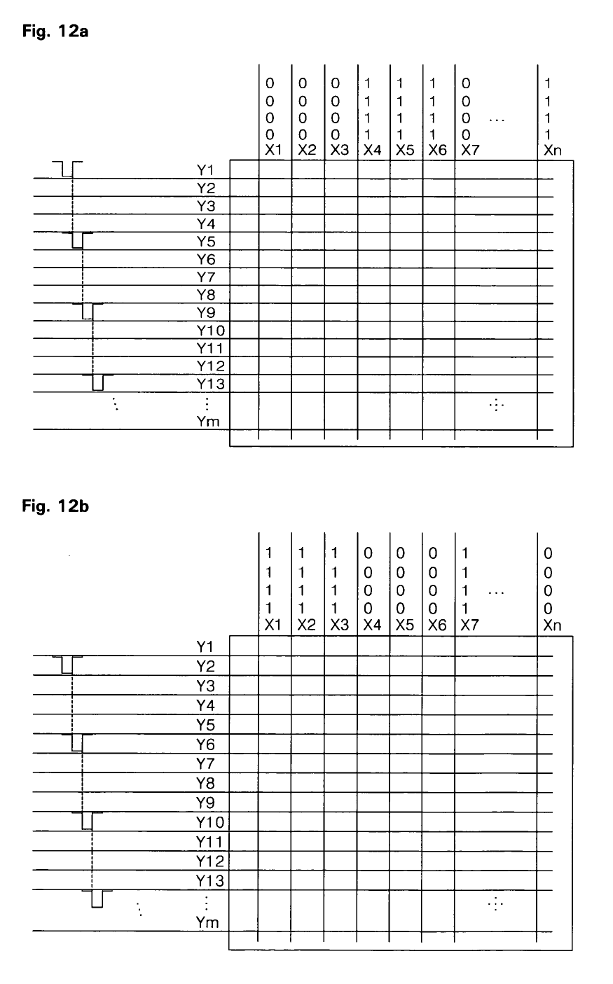

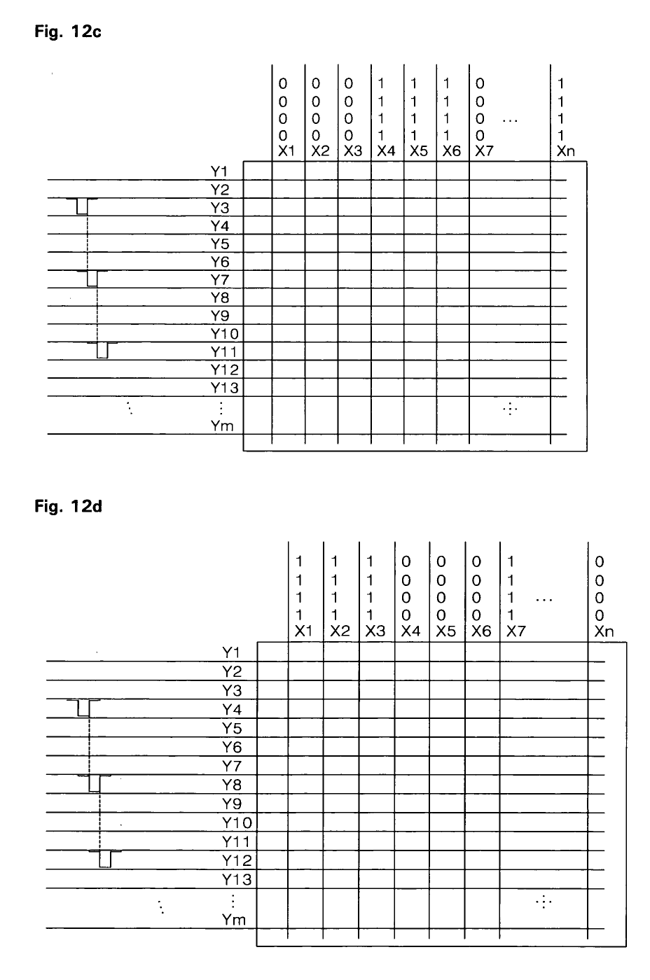

On the other hand, even when the data pattern where the high logic and the low logic are repeated in the column direction and the row direction of the pixel cell (20) is inputted as shown in FIG. 4, the scan driver (52) supplies the scan pulse dividedly to the i^{th} scan electrode (Yi), (i+1)^{th} scan electrode (Yi+1), (i+2)^{th} scan electrode (Yi+2), (i+₃)^{th} scan electrode (Yi+3) as shown in FIGS. 12A to 12D.

Then, as shown in FIGS. 12A to 12D, when the scan pulse is supplied to the i^{th} scan electrode (Yi) (the first block), (i+1)^{th} scan electrode (Yi+1) (the second block), (i+2)^{th} scan electrode (Yi+2) (the third block), (i+3)^{th} scan electrode (Yi+3) (the fourth block), the data signal of the same polarity is supplied to each of the data electrodes (X1 to Xn). In fact, the polarity of the data signal supplied to each of the data electrodes (X1 to Xn) is changed when the scan pulse is supplied to the the first (i+1)^{th} scan electrode (Yi+1) (the first scan electrode of the second block), the first (i+2)^{th} scan electrode (Yi+2) (the first scan electrode of the third block) and the first (i+3)^{th} scan electrode (Yi+3) (the first scan electrode of the the fourth block), but maintains the same polarity in the other cases.

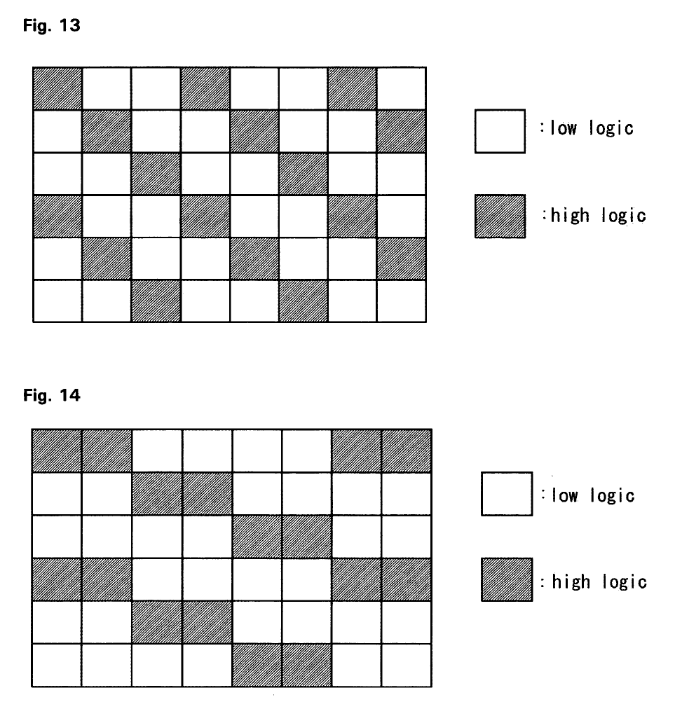

Furtheremore, as shown in FIGS. 13 and 14, even in case of adapting the aforementioned scanning method to the data pattern looking as if the same logic pattern was repeated for every two scane electrodes, a change of the logic in the same electrode upon scanning is reduced, thereby reducing the power consumption and minimizing the switching frequency of the switching devices included in the data driver. That is, in case of scanning the data pattern as shown in FIGS. 13 and 14, it is possible to reduce the power consumption and minimize the switching frequency of the switching devices included in the data driver by supplying the scan pulse to the i^{th} scan electrode (Yi) (the first block), (i+1)^{th} scan electrode (Yi+1) (the second block), (i+2)^{th} scan electrode (Yi+2) (the third block), and (i+3)^{th} scan electrode (Yi+3) (the fourth block) as in FIGS. 12A to 12D.

On the other hand, the data signal control method of the plasma display panel according to the embodiment of the present invention in FIGS. 5 to 12, is explained with respec to a method of dividing the scan electrodes into two or more blocks at equal spacings, but the spirit and scope of the invention is not limted to this. For example, in case of dividing the scan electrodes into four blocks, the present invention may be applicable to other block configurations having the same repeat data pattern [(0, 1, 0, 1, 0, 1) and (1, 0, 1, 0, 1, 0)] but not having equal spacings, as well as the (Y1, Y5, Y9, . . . ), (Y2, Y6, Y10, . . . ), (Y3, Y7, Y11, . . . ), (Y4, Y8, Y12, . . . ) block configuration explained in FIGS. 11 to 12. In other words, the block composition of the odd numbered scan electrode to which the same repeat data pattern is applied might be made as in (Y3, Y7, Y9, Y11, . . . ), (Y5, Y13, Y17, Y19, . . . ) and (Y1, Y15, Y21, Y25, . . . ). Further, the number of the scan electrode included in each block might be the same or different.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus including scan electrodes and data electrodes intersecting the scan electrodes, the apparatus comprising:
a scan driving unit that scans the scan electrodes according to a scan sequence;
a data driving unit that supplies a data signal corresponding to the scan sequence to the data electrodes; and
a control unit that controls the scan driver and the data driver; the control unit controlling the scan driver in order to perform a first scan for sequentially scanning odd numbered scan electrodes, and a second scan for sequentially scanning even numbered scan electrodes, when input data includes a data pattern which repeats a logical inversion for cells in a column direction.

2. The plasma display apparatus as claimed in claim 1, wherein the control unit controls the scan driver in order to repeat the first scan for sequentially scanning two or more odd numbered scan electrodes and the second scan for sequentially scanning two or more even numbered scan electrodes.

3. The plasma display apparatus as claimed in claim 1, wherein the cell is a pixel.

4. The plasma display apparatus as claimed in claim 1, wherein the cell is a sub-pixel.

5. The plasma display apparatus as claimed in claim 1, wherein the cell is a discharge cell.

6. A plasma display apparatus including a plurality of scan electrodes, and plurality of data electrodes crossing the plurality of scan electrodes, the apparatus comprising:
a scan driver that consecutively scans non-adjacent scan electrodes, when data supplied to cells at the intersections of the non-adjacent electrodes and at least one data electrode have the same logic level; and
a data driver for supplying a data signal to the plurality of data electrodes that corresponds to the scan.

7. A plasma display apparatus comprising:
scan electrodes;
data electrodes crossing the scan electrodes;
cells arranged at intersections of the scan electrodes and the data electrodes;
a scan driver for scanning every other scan electrode, when a data pattern supplied to the cells is inverted in each sub-pixel cell in a column direction; and
a data driver for supplying a data signal to the data electrodes that corresponds to the scanning sequence of the scan driver.

8. The plasma display apparatus as claimed in claim 7, wherein the cell is a pixel.

9. The plasma display apparatus as claimed in claim 7, wherein the cell is a sub-pixel.

10. The plasma display apparatus as claimed in claim 7, wherein the cell is a discharge cell.

11. A driving method for a plasma display apparatus having a plurality of scan electrodes, and a plurality of data electrodes crossing the plurality of scan electrodes, comprising:
consecutively scanning non-adjacent scan electrodes, when data supplied to cells at the intersections of the non-adjacent scan electrodes and at least one of the plurality of data electrodes have the same logic level; and
supplying a data signal to the plurality of data electrodes that corresponds to the scanning sequence.

12. The driving method as claimed in claim 11, wherein the cells are pixels.

13. The driving method as claimed in claim 11, wherein the cells are sub-pixels.
